(19) United States
(12) Patent Application Publication
(10) Pub. No.: US 2026/0192243 A1
(43) Pub. Date: Jul. 9, 2026

(54) Glycol Regeneration Off-Gas System Design Enhancement Using Jacketed Gas Thermocompressor

(71) Applicant: Saudi Arabian Oil Company, Dhahran (SA)

(72) Inventor: Khalid Saeed Babtain, Al Hofuf (SA)

(21) Appl. No.: 19/013,615

(22) Filed: Jan. 8, 2025

(51) Int. Cl. B01D 53/26; B01D 53/14; B01D 53/28; C10L 3/10

(52) U.S. Cl. CPC B01D 53/263; B01D 53/1425; B01D 53/28; C10L 3/106; B01D 2252/2023; B01D 2256/24; B01D 2257/80

(57) ABSTRACT

A method of regenerating glycol from a rich glycol stream. The method includes regenerating glycol by stripping water from the rich glycol stream in a stripper and generating a stripped gas including vapor and a liquid including lean glycol, where the stripped gas has an initial pressure and temperature, and a water content of the lean glycol is less than the rich glycol stream. The method further includes providing the stripped gas to a jacketed gas thermocompressor, and flowing a fuel gas stream into the jacketed gas thermocompressor as a motive fluid. The method further includes flowing a heat exchanging fluid into a jacket of the jacketed gas thermocompressor, and discharging a cooled output stream from the jacketed gas thermocompressor. The cooled output stream has an output pressure higher than the initial pressure of the stripped gas and an output temperature lower than the initial temperature of the stripped gas.

### TECHNICAL FIELD

This disclosure relates to glycol regeneration.

### BACKGROUND

Gas dehydration is a process in the natural gas industry used to remove water from natural gas to meet sales gas specifications. Absorption dehydration that uses glycols such as tri-ethylene glycol (TEG) is widely adopted in industry due to its simplicity, low capital, and operating costs. To maintain the efficiency of this process, the used glycol containing water, referred to as rich glycol, is often processed further to regenerate lean glycol by removing absorbed water and contaminants. This regeneration typically involves heating the rich glycol to evaporate the water, followed by condensation and separation of the vapor. System design for the glycol regeneration can play a major role in improving the energy efficiency, reducing the greenhouse gas (GHG) emissions, and minimizing system capital cost.

### SUMMARY

This disclosure describes technologies relating to a novel glycol regeneration off-gas system design enhancement using jacketed gas thermocompressor and the method of using the same. In various implementations, the jacketed gas thermocompressor replaces a commonly used high-pressure (HP) steam ejector and a cooler, significantly improving the energy efficiency of the glycol regeneration process and reducing the volume of wastewater. Typical compression designs with a HP steam often require significant energy input to allow high temperature operations, e.g., from about 400° F. (204° C.) to about 720° F. (382° C.), and cool down the output stream after the compressor to meet downstream facility temperature requirements. The jacketed gas thermocompressor of this disclosure enables the use of a fuel gas, e.g., a dry hydrocarbon stream, as a motive fluid and can substantially lower the temperature of the output stream, e.g., about 120° F. (48.9° C.), eliminating the need of cooling equipment. Further, replacing the HP steam with the fuel gas can also reduce the volume of wastewater and thereby the size of off-gas system.

### BRIEF DESCRIPTION OF DRAWINGS

FIG. 1 is a schematic illustration of a glycol regeneration system including an off-gas system with a jacketed gas thermocompressor.

FIG. 2 is a schematic illustration of a jacketed gas thermocompressor.

FIG. 3 is an example process flow diagram of methods of glycol regeneration using a jacketed gas thermocompressor.

### DETAILED DESCRIPTION

Implementations described herein provide a novel glycol regeneration off-gas system using jacketed gas thermocompressor and the method of using the same. Generally, gas dehydration in the natural gas industry to remove water is performed by an absorption process using an adsorbent such as triethylene glycol (TEG), diethylene glycol (DEG), ethylene glycol (MEG), and tetraethylene glycol (TREG). The regeneration of the spent glycol is a crucial part of the overall glycol-based gas dehydration process. This separation of water from the glycol/water mixture requires substantial energy input for heating and vaporizing the water fraction. Accordingly, improving the glycol recovery process design may be desired for better energy efficiency and reduction of GHG emissions.

In various implementations, the jacketed gas thermocompressor replaces the commonly used high-pressure (HP) steam ejector and cooler. This substitution significantly improves the energy efficiency of the glycol regeneration process and leads to various process, cost, and environmental improvements, while achieving the required off-gases stripping pressure in glycol regeneration processes. For example, various implementations can eliminate the need of cooling equipment, recover the energy from the motive fluid in the downstream fired equipment, and eliminate the stacks' black smoke in the downstream fired equipment. The suppression of black smoke can improve the stability of fired equipment flame. The substitution of HP steam with a fuel gas can also reduce the volume of wastewater produced. Many of these improvements can enable reducing the size of off-gas system, making the jacketed gas thermocompressor a more sustainable and efficient alternative. The energy efficiency can be improved at least in part by recovering energy otherwise wasted in conventional HP steam-based systems.

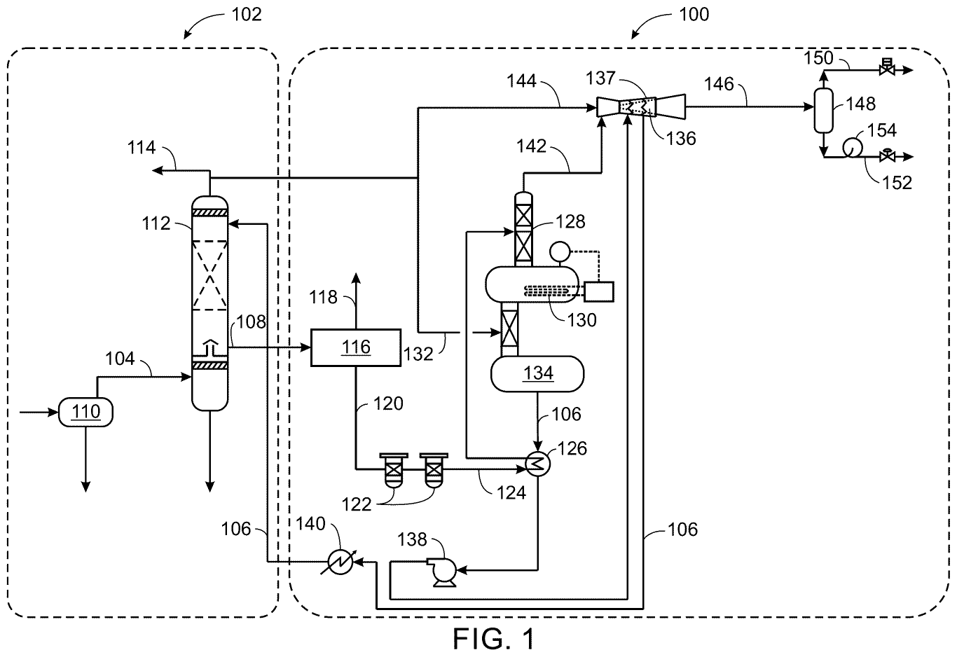

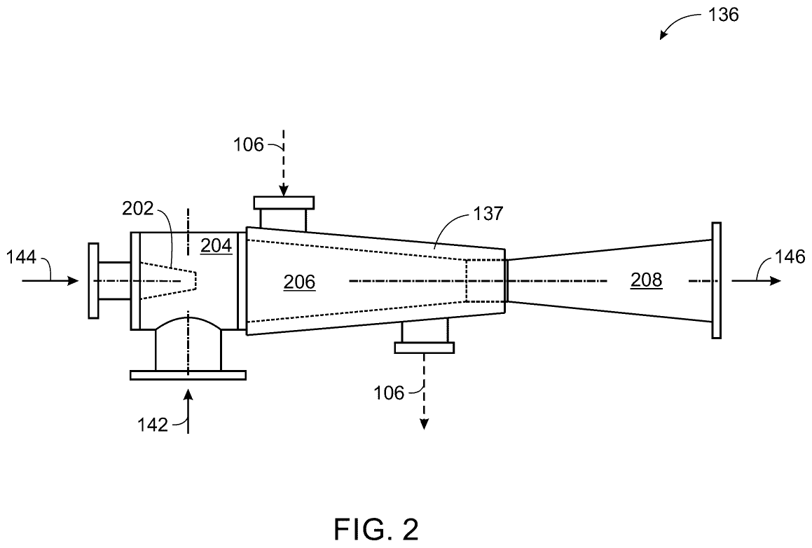

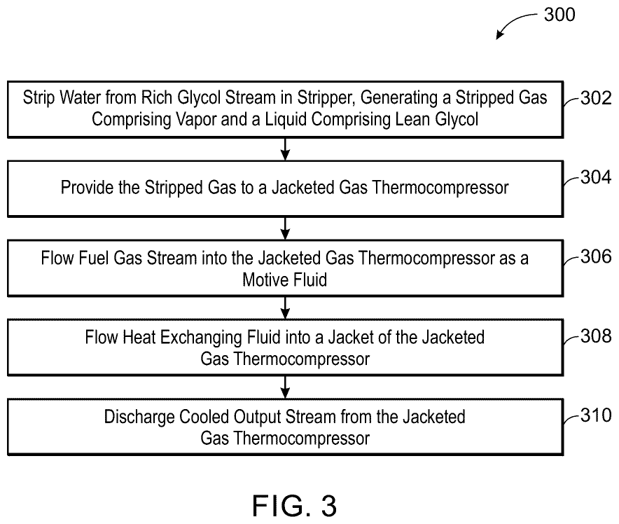

In the following, referring to FIG. 1, the system design is described in order of gas dehydration, glycol regeneration, and off-gas system with a jacketed gas thermocompressor. An example of the jacketed gas thermocompressor is then described referring to FIG. 2. A process flow of the method of glycol regeneration using the off-gas system with the jacketed gas thermocompressor is described in FIG. 3.

### Gas Dehydration System

In FIG. 1, it shows a complete gas dehydration system, a glycol regeneration system 100 is coupled to and disposed to downstream to a gas dehydration absorption system 102. In various implementations, the gas dehydration absorption system 102 dehydrates a wet gas 104 using lean glycol 106 as an absorber, and the spent glycol, referred to as rich glycol 108 can be fed to the glycol regeneration system 100 to regenerate the lean glycol 106. In this disclosure, any spent stream of water-containing glycol or glycol mixture prior to dehydration processes can be referred to as rich glycol. The removal of the absorbed water from the rich glycol 108 can result in the glycol stream referred to as the lean glycol 106. In various implementations, the water content of the lean glycol 106 is less than the rich glycol 108. Further, the lean glycol 106 can be substantially free of water, and thus the water content of the lean glycol 106 in this disclosure includes zero or below instrument detection level for water content. In various implementations, the lean glycol has a glycol purity of 99% or higher.

Still referring to FIG. 1, the wet gas 104 can be wet natural gas or other hydrocarbon streams containing water. In some implementations, the wet gas 104 can be a gas stream after processes such as sweetening to remove acidic gases present in natural gas. As illustrated in FIG. 1, the wet gas 104 can be first treated in a separator 110 for partial water and condensate removal. In some implementations, although not specifically illustrated in FIG. 1, the separator 110 is preceded by a chiller/cooler to achieve partial water and condensate removal from the wet gas 104. The wet gas 104 can then be fed to a scrubber 112 for the main dehydration process. In various implementations, the scrubber 112 is a glycol contactor separation column that includes an absorber structured packing or trays within the column. The wet gas 104 can be introduced in the bottom of the column while the lean glycol 106, as an absorber, can be introduced near the top of the column to enable a counter-current flow absorption process.

A portion or all of the lean glycol 106 can be the regenerated glycol obtained from the glycol regeneration system 100. The purity of the glycol in the lean glycol can be 99% or higher, for example, 99.8% or higher. In various implementations, the glycol can be mono-ethylene glycol (MEG), di-ethylene glycol (DEG), tri-ethylene glycol (TEG) tetra-ethylene glycol (TREG), or any combination of them.

A dried treated gas 114 can exit the scrubber 112 from the top and be transferred for further processing. In various implementations, the dried treated gas 114 contains 20-140 ppm water. In some implementations, although not specifically illustrated in FIG. 1, the gas dehydration absorption system 102 includes a heat exchanger to cool the lean glycol 106 entering the scrubber 112. The dried treated gas 114 can pass through the heat exchanger to absorb heat from the lean glycol 106 in order to keep the required temperature difference for absorption. The dried treated gas 114 can be in the shell or tube of a cooler 140 as described below.

### Glycol Regeneration System

As further illustrated in FIG. 1, the rich glycol 108 generated by the gas dehydration process can be transferred to the glycol regeneration system 100. In various implementations, the rich glycol 108 is first led to a flash drum 116 for flashing hydrocarbons 118 present in the rich glycol, referred to as associated hydrocarbons in some cases. The pressure of the flash drum 116 can be maintained at a temperature suitable for the flashing, e.g., about 55 psig (379.2 kPa). A flashed rich glycol 120 can then pass through multiple stages of filtration in a filter system 122 for solid and hydrocarbons removal. The filter system 122 can include one or more mechanical, guard, and carbon/charcoal filters. A filtered rich glycol 124 can be heated by a heat exchanger 126, also referred to as a lean/rich glycol exchanger, before entering a stripper column 128 and a reboiler 130 disposed below the stripper column. The stripper column 128 and the reboiler 130 can be collectively referred to as a stripper in this disclosure.

In various implementations, the reboiler 130 is maintained a temperature suitable for water removal without degrading or vaporing the glycol, e.g., about 392° F. (200° C.). A side stream 132 can be introduced to the stripper as a stripping gas to enhance the glycol purity and water removal from the glycol by lowering the partial pressure of the water in the stripper system. In some implementations, as illustrated in FIG. 1, the side stream 132 can be obtained from the dried treated gas 114. The lean glycol 106 can be regenerated in the stripper system and transferred to and stored in a surge tank 134, also referred to as a glycol accumulator. The lean glycol 106 is recovered from the stripper system as a hot stream and it can be cooled using the heat exchanger 126, using the recovered heat to warm the filtered rich glycol 124.

As further illustrated in FIG. 1 and described below, the lean glycol 106 regenerated in the stripper system and pumped by a glycol circulation pump 138. Following that, it can be further used as a heat exchanging fluid for a jacketed gas thermocompressor 136 having a heat exchange jacket 137 in the off-gas system. After passing through the jacketed gas thermocompressor 136, the lean glycol 106 can be cooled by the cooler 140 to maintain required temperature difference for absorption before entering the scrubber 112 for the gas dehydration. In some implementations, the cooler 140 can be a heat exchanger using the dried treated gas 114 to cool the lean glycol 106.

In FIG. 1, the schematic of the glycol regeneration system 100 and the gas dehydration absorption system 102 is simplified for illustration purpose, including its size and dimensions, relative positions of each components, and the number of each component. For example, only one scrubber is illustrated in FIG. 1, for illustration purposes, but in various implementations, any number of separation columns can be used for the gas dehydration. Further, in some implementations, one or more components can be omitted or additional components can be present. For example, additional filters, circulation pumps, heat exchangers can be included.

### Off-Gas System

Some implementations of the glycol regeneration system 100 of this disclosure are further characterized with the use of the jacketed gas thermocompressor 136 in the off-gas system to treat a stripped gas 142 from the stripper column 128. In this disclosure, the jacketed gas thermocompressor 136 includes and can be referred to as an ejector, educator, Jut pump, glycol jacketed gas thermocomprssor, or glycol jacketed gas ejector.

The off-gas system is designed to treat the stripped gas 142 to separate the condensate of water and hydrocarbon from off-gases, and in various implementations, the use of jacketed gas thermocompressor and process design can offer advantages over the currently available off-gas systems. The advantages can include the improvement of energy efficiency, emission reduction, reduction of wastewater volume, and elimination or resizing of some of the off-gas system components, e.g., off-gas cooler and condensate pumps. Specifically, the off-gas system improved design can achieve the required off-gases stripping pressure in glycol regeneration processes, while also enabling recovering motive fluid energy in the downstream fired equipment and eliminating the stacks' black smoke in the downstream fired equipment and thereby stabilizing fired equipment flame.

Conventional off-gas systems may be composed of an HP steam ejector, off-gas condenser/cooler, off-gas knockout (K.O.) drum, and off-gas condensate pumps. The use of HP steam as a motive fluid requires air-coolers operated by motors to condense all steam quantities from the ejector in addition to the stripped moisture. Further, the HP steam ejector typically operates at high temperatures, e.g., from about 400° F. (204° C.) to about 720° F. (382° C.), which needs to be brought down for condensation and meeting downstream facility temperature requirements. This off-gas setup also necessitates maintaining the stripper overhead temperature at the water equilibrium curve. These factors collectively make the process significantly energy intensive. In addition to the energy intensity, these conventional approaches may generate substantial amount of wastewater. The condensed water produced from the steam ejector and stripper column increases the off-gas drum level, leading to larger pump capacity requirements. The large volume of condensed water may also increase the level of moisture carryover in the off-gas and thereby impact the application of the off-gas. For example, where the off-gas is used as a fuel at a flare stack or any fired equipment, the moisture carry over can affect the flame stability and cause black smoke in downstream fired equipment. The condensed water can be oily water containing hydrocarbon impurities such as benzene, toluene, and xylene (BTX), and can be subject to further water treatment processes such as sour water treatment.

In various implementations, commonly used HP steam for the motive fluid is replaced with a gas stream 144 such as a hydrocarbon gas stream. As illustrated in FIG. 1, the gas stream 144 can use the dried treated gas 114. In some implementations, the gas stream 144 is flowed into the jacketed gas thermocompressor 136 at a flow rate high enough to enable the suction of the stripped gas 142. The flow rate of the motive fluid can be from about 4000 lb/h (1814.4 kg/h) to about 8000 lb/h (3628.7 kg/h) based on train capacity, for example about 5704 lb/h (2587.3 kg/h).

Using the gas stream 144 instead of HP steam as the motive fluid, the jacketed gas thermocompressor 136 can be operated at a much lower temperature, e.g., below 400° F. (204° C.), compared to the HP steam system. For example, the gas stream 144 can be fed into the jacketed gas thermocompressor 136 at a temperature from about 80° F. (26.7° C.) to about 100° F. (37.8° C.). In some implementations, the initial temperature of the stripped gas 142 at the entry to the jacketed gas thermocompressor 136 can be from about 180° F. (82.2° C.) to about 250° F. (121.1° C.), for example, about 200° F. (93.3° C.). Accordingly, an output stream 146 can also have a lower temperature compared to the conventional HP steam-based off-gas systems. In some implementations, the temperature of the output stream 146 can be from about 100° F. (37.8° C.) to about 150° F. (65.6° C.), for example, about 120° F. (48.9° C.). The substantially lower operating and fluid temperatures enabled by eliminating the use of HP steam can reduce the input energy and thereby GHG emissions from the off-gas system. Further, in some implementations, the lower temperature of the output stream 146 can eliminate the use of off-gas coolers completely, advantageously reducing the number of components for the off-gas system. The output stream 146 can be cool enough to allow the water content to be condensed without needing an additional cooling system.

In various implementations, the gas stream 144 can be fed into the jacketed gas thermocompressor 136 at a pressure from about 300 psig (2068 kPa) to about 1000 psig (6894.7 kPa), for example about 500 psig (3447 kPa). In some implementations, the initial pressure of the stripped gas 142 at the entry to the jacketed gas thermocompressor 136 can be from about 0.1 psig (0.7 kPa) to about 8.0 psig (55.2 kPa), for example, about 4 psig (27.6 kPa). Further, the pressure of the output stream 146 can be from about 20 psig (137.9 kPa) to 50 psig (344.7 kPa), for example, about 30 psig (206.8 kPa). In some implementations, the pressure of the output stream 146 can be controlled in view of the required off-gas pressure for subsequent processes and equipment.

The jacketed gas thermocompressor 136 can circulate a heat exchanging fluid to enable heat exchange between the heat exchanging fluid and the gas mixture of the stripped gas 142 and the motive fluid, e.g., the gas stream 144. In various implementations, this heat exchange can prevent frost (hydrate) buildup in a nozzle section of the jacketed gas thermocompressor 136. As further illustrated in FIG. 1, in some implementations, at least a portion of the lean glycol 106 regenerated and recovered in the glycol regeneration process can be used for the heat exchanging fluid for the jacketed gas thermocompressor 136. For example, the lean glycol 106 can be flowed from the surge tank 134 first to the heat exchanger 126 for heating the filtered rich glycol 124, and then pumped by the glycol circulation pump 138 into the heat exchange jacket 137 of the jacketed gas thermocompressor 136. In some implementations, where the lean glycol 106 is used for the heat exchanging fluid, the temperature of the heat exchanging fluid can be lowered by the heat exchange with a minimal degree, for example about 2-3° F. (1.1-1.7° C.). While the lean glycol 106 is used for the heat exchanging fluid in FIG. 1, in other implementations, a different fluid can be used. The fluid can include a glycol, e.g., lean glycol, rich glycol, or any glycol compounds, or a non-glycol stream, e.g., steam or hot oil. In some implementations, an electric heat exchanger can be used instead of or in addition to the heat exchanging fluid.

The output stream 146 can be a gas/liquid mixture fluid that can be separated using an off-gas knockout (K.O.) drum 148 into an off-gas 150 and an oily water 152. In various implementations, the off-gas 150 is primarily comprised of hydrocarbons with minimal amount of moisture and the oily water 152 can be wastewater containing residual contaminants such as BTX. In various implementations, the oily water 152 can be transferred to an evaporation pod as wastewater with or without further treatment such as sour water treatment.

The off-gas 150 can be used as a fuel gas at a flare stack or any downstream fired equipment. In some implementations, the hydrocarbons 118 flashed using the flash drum 116 from the rich glycol 108 are combined with the output stream 146 from the jacketed gas thermocompressor 136 to be recovered as a part of the off-gas 150.

This off-gas system with the jacketed gas thermocompressor 136 can offer several other benefits to the overall energy and process efficiency of the glycol regeneration system 100. For example, the use of a hydrocarbon gas stream, e.g., the dried treated gas 114, for the motive fluid to drive the jacketed gas thermocompressor 136 enables the recovery of the motive fluid as a fuel gas that can be combusted to power any fired equipment adjacent or included in the glycol regeneration system 100. This is in contrast to the conventional HP steam-based system, where the steam needs to be condensed together with the vapor in the stripped gas and most of the energy in the steam is not recovered. Further, the volume of the oily water 152 can be substantially reduced thanks to not using the steam from the off-gas system. This volume reduction can lighten the burden on the wastewater treatment equipment, thus reducing the size of a condensate pump 154, for example. The quality of the off-gas 150 can also be improved by minimizing the residual moisture in the gas. The more dried off-gas stream can lead to stable flame in the fired equipment that utilized the off-gases.

FIG. 2 is a schematic illustration of a jacketed gas thermocompressor 136 in accordance with an implementation. In FIG. 2, the jacketed gas thermocompressor 136 has four distinct sections: a nozzle section 202, a suction chamber section 204, a compression section 206, and a diffuser section 208, for optimizing the compression and handling of the gases. In the nozzle section 202, the motive fluid, e.g., the gas stream 144, enters jacketed gas thermocompressor 136 and the stripped gas 142 are introduced into the suction chamber section 204. Injecting the gas stream 144 as motive at a high pressure and velocity from the nozzle, which causes the stripped gas 142 inside the chamber to be expelled from the stripper column 128 at a high velocity as well. The result of this process is that it creates an area of low pressure inside the system, creating a vacuum. The compression section 206 is where the actual compression of the mixture gas takes place. As illustrated in FIG. 2, it can be surrounded by a heat exchange jacket 137, through which a heat exchanging fluid passes. As described above, in various implementations, the lean glycol 106 collected from the glycol regeneration process can be used as the heat exchanging fluid for the jacket. The purpose of the jacket is to allow the heat exchanging fluid to provide heat to thermocompressor shell and regulate the temperature within the compression section 206, preventing frost (hydrate) buildup in the jacketed gas thermocompressor 136. The inner diameter of the chamber of the compression section can be narrowed along with the axial direction of the jacketed gas thermocompressor 136. In the diffuser section 208, the compressed gas is collected and discharged as the output stream 146.

FIG. 3 is an example process flow diagram of methods of glycol regeneration using a jacketed gas thermocompressor. A process 300 starts with a step 302 of regenerating glycol by stripping water from a rich glycol stream in a stripper, generating a stripped gas including vapor and a liquid including lean glycol, where the stripped gas has an initial pressure and an initial temperature. At a step 304, the stripped gas is provided to a jacketed gas thermocompressor, followed by a step 306 of flowing a fuel gas stream into the jacketed gas thermocompressor as a motive fluid for the jacketed thermocompressor. At a step 308, a heat exchanging fluid is flowed into a jacket of the jacketed gas thermocompressor, and at a step 310, a cooled output stream is discharged from the jacketed gas thermocompressor. Here, the cooled output stream has an output pressure higher than the initial pressure of the stripped gas and an output temperature lower than the initial temperature of the stripped gas.

### Examples

In accordance with an implementation of the off-gas system using a jacketed gas thermocompressor, Aspen HYSYS® simulation was conducted for a set of process parameters for a motive fluid and a stripped gas from the stripper. Table 1 provides the process parameters of suction load, e.g., the stripped gas 142 in FIG. 1, and motive section, e.g., the gas stream 144 in FIG. 1, used for the simulation of the discharge stream. To examine the capability of low-temperature operation, the motive section temperature was set at 82° F. (27.8° C.). The simulated parameters of the discharge stream, e.g., the output stream 146 in FIG. 1, is also included in Table 1. The simulation results demonstrate that suitable temperature (~207 kPa) and pressure (49° C.) of the discharge stream can be achieved without using off-gas coolers that are required in conventional HP steam-based off-gas systems.

TABLE 1
Parameters used for Aspen HYSYS ® simulation
and simulated values

| Parameter | Suction load | Motive section | Discharge |
|---|---|---|---|
| Flow rate | 2035 lb/h | 5704 lb/h | 7739 lb/h |
| | (923.1 kg/h) | (2587.3 kg/h) | (3510.4 kg/h) |
| Pressure | 4 psig | 505 psig | 30 psig |
| | (27.6 kPa) | (3481.9 kPa) | (206.8 kPa) |
| Temperature | 203° F. | 82° F. | 119.32° F. |
| | (95° C.) | (27.8° C.) | (48.5° C.) |
| Specific heat | 0.75 BTU/lb · ° F. | 0.6 BTU/lb · ° F. | — |
| | (3140 J/kg · ° C.) | (2512 J/kg · ° C.) | |
| Molecular | 20.32 | 20.63 | — |
| Weight | | | |
| Composition | Gas | Gas | Gas/Liquid |

In accordance with an implementation, the jacketed gas thermocompressor can be constructed with specifications as follows: a high-pressure compatible compressor body can be manufactured following construction code ASME Sect. VIII Div 1/HEI; the ejector diffuser and air chamber sections can be made of steel; the motive fluid nozzle can be made of SAE 316L grade stainless steel (SS); alloy steel can be used for bolting; and flexible graphite materials, e.g., GraFoil®, can be used for gaskets.

In some implementations, the gas dehydration system with glycol regeneration is a part of oil refinery, gas plant, or a gas-oil separation plant (GOSP). The water-rich TEG was regenerated and continuously recycled back for reuse in the system.

Further, energy conservation, emission reduction, and economic savings possible from the implementation of the off-gas system with the jacketed gas thermocompressor were estimated in a case study. The summary of the estimation is provided for a single dehydration train based on Saudi Aramco's Hawiyah Gas Plant in Table 2. The savings in the estimation include, for example, the elimination of a 30 hp (22.4 kW) off-gas cooler, and the fuel gas equivalent to 0.4 MMSCFD (million standard cubic feet per day) (11326 cubic meters per day) otherwise wasted due to flaring. Further, the use of fuel gas stream can reduce the volume of oily water from about 10 gallons per minute (GPM) (37.9 L/min) to about 4 GPM (15.1 L/min) by about 6 GPM (22.7 L/min). The total cost savings per train per year can be up to $124K, while the capital cost for installing a jacketed gas thermocompressor is estimated to be around $44K. The capital cost savings can include smaller off-gas system and pumps size and the elimination of off-gas coolers. As described, the substitution of the jacketed gas thermocompressor for the off-gas system can result in substantial energy, emission, and cost savings, contributing to achieving the net zero emission global initiatives and operation decarbonization.

TABLE 2
Estimation of energy, emission, and cost savings

| | Yearly energy | | Yearly CO₂ | | Yearly cost |
|---|---|---|---|---|---|
| Saving item | savings | | reduction | | savings |
| Oily water treatment | 87.6 | MWh | 63.6 | ton | $4905 |
| improvement (5% sour | | | | | |
| water train) | | | | | |
| Eliminating off-gas | 196 | MWh | 142.3 | ton | $10976 |
| cooler (30 hp) | | | | | |
| Avoiding flaring from | 11137 | MWh | 2031.5 | ton | $81700 |
| stack black smoke | | | | | |
| (~0.4 MMSCFD) | | | | | |
| Eliminating spare parts | Transportation | | Transportation | | $10500 |
| and labor for off-gas | | | | | |
| cooler | | | | | |
| Oily water volume | 6 GPM | | 6 GPM | | about 15% |
| reduction | (22.7 L/min) | | (22.7 L/min) | | saving |
| Glycol cooling duty | 2-3° F. | | 2-3° F. | | |
| reduction | (1.1-1.7° C.) | | (1.1-1.7° C.) | | |
| Piping length reduction | varies | | varies | | |
| Total saving per train | 11421 | MWh | 2237.4 | ton | $124,293 |
| Total saving per facility | 68562 | MWh | 13424.4 | ton | $745,758 |
| Total saving for ~30 | 342810 | MWh | 67122 | ton | $3,728,790 |
| glycol trains | | | | | |

### Implementations

An implementation described in this disclosure provides a method of regenerating glycol from a rich glycol stream. The method includes regenerating glycol by stripping water from the rich glycol stream in a stripper and generating a stripped gas including vapor and a liquid including lean glycol, where the stripped gas has an initial pressure and an initial temperature, and a water content of the lean glycol is less than that of the rich glycol stream. The method further includes providing the stripped gas to a jacketed gas thermocompressor, and flowing a fuel gas stream into the jacketed gas thermocompressor as a motive fluid for the jacketed gas thermocompressor. The method further includes flowing a heat exchanging fluid into a jacket of the jacketed gas thermocompressor, and discharging a cooled output stream from the jacketed gas thermocompressor. The cooled output stream has an output pressure higher than the initial pressure of the stripped gas and an output temperature lower than the initial temperature of the stripped gas.

In an aspect, combinable with any other aspect, the cooled output stream is a mixture of the stripped gas and the fuel gas stream, and a temperature of the cooled output stream is low enough to allow condensation of the water without an additional cooler system.

In an aspect, combinable with any other aspect, the cooled output stream is a mixture of the stripped gas and the fuel gas stream, the method further including recovering the fuel gas stream as an off-gas.

In an aspect, combinable with any other aspect, the method further includes combusting the off-gas as a fuel.

In an aspect, combinable with any other aspect, the method further includes performing a gas dehydration absorption process of a wet gas using the lean glycol to generate a dry gas and the rich glycol stream including the water.

In an aspect, combinable with any other aspect, the wet gas includes hydrocarbons, where the method further includes, prior to stripping the water from the rich glycol stream in the stripper, removing at least a portion of associated hydrocarbons in the rich glycol stream using a flash drum.

In an aspect, the wet gas includes hydrocarbons, and the method further includes using at least a portion of the dry gas as the fuel gas stream flowed into the jacketed gas thermocompressor.

In an aspect, combinable with any other aspect, the method further includes using at least a portion of the lean glycol from the stripper as the heat exchanging fluid for the jacketed gas compressor.

In an aspect, combinable with any other aspect, the method further includes pressurizing at least a portion of the lean glycol from the stripper using a pump, generating a pressurized lean glycol; and using the pressurized lean glycol as the heat exchanging fluid for the jacketed gas compressor.

In an aspect, the method further includes collecting the heat exchanging fluid after the jacketed gas compressor; and performing a gas dehydration absorption process of a wet gas using the collected heat exchanging fluid to generate a dry gas and the rich glycol stream.

In an aspect, combinable with any other aspect, the initial pressure of the stripped gas from glycol stripper is from 0.1 psig (0.69 kPa) to 8.0 psig (55.2 kPa), and the output pressure is from 20 psig (137.90 kPa) to 50 psig (344.74 kPa).

In an aspect, combinable with any other aspect, the initial temperature is from 180° F. (82.2° C.) to 250° F. (121.1° C.), and the output temperature is from 100° F. (37.8° C.) to 150° F. (65.6° C.).

In an aspect, combinable with any other aspect, the rich glycol includes hydrocarbons, and the method further includes stripping the hydrocarbons from the rich glycol stream in the stripper while stripping the water.

An implementation described in this disclosure provides a glycol regeneration system including: a stripper to extract water from rich glycol stream and to generate a stripped gas including vapor and a liquid including lean glycol, the stripper including a reboiler and a stripping column; a surge tank downstream to the stripper to store the lean glycol; and a jacketed gas thermocompressor downstream to the stripper to receive, heat, and compress the stripped gas. The jacketed gas thermocompressor includes a jacket to receive at least a portion of the lean glycol as a heat exchanging fluid, and a water content of the lean glycol is less than that of the rich glycol stream.

In an aspect, combinable with any other aspect, the glycol regeneration system further includes a flash drum upstream to the stripper to remove at least a portion of associated hydrocarbons in the rich glycol stream.

In an aspect, combinable with any other aspect, the glycol regeneration system further includes a filter upstream to the stripper to remove at least a portion of solids and associated hydrocarbons in the rich glycol stream.

In an aspect, combinable with any other aspect, the glycol regeneration system further includes a heat exchanger to exchange heat between the rich glycol stream and the lean glycol.

In an aspect, combinable with any other aspect, an implementation provides a gas dehydration absorption system including the glycol regeneration system, where the gas dehydration absorption system further includes a scrubber to treat a wet gas and generate a dry gas and the rich glycol stream.

In an aspect, combinable with any other aspect, the gas dehydration absorption system further includes a fluid connection from a gas outlet of the scrubber to a motive fluid inlet of the jacketed gas thermocompressor.

In an aspect, combinable with any other aspect, the gas dehydration absorption system further includes a fluid connection from an outlet of the jacket for the heat exchanging fluid to an absorber inlet of the scrubber.

An implementation described in this disclosure provides a method of dehydrating a wet hydrocarbon gas. The method includes dehydrating the wet hydrocarbon gas in a scrubber using a lean glycol as an absorber, generating a dry hydrocarbon gas and a rich glycol stream including water and hydrocarbon impurities. The method further includes removing at least a portion of the hydrocarbon impurities from the rich glycol stream in a flash drum. The method further includes heating the rich glycol stream in a stripper to vaporize the water and the remaining hydrocarbon impurities as a stripped gas, leaving a regenerated glycol stream as a liquid. The method further includes compressing the stripped gas using a jacketed gas thermocompressor by flowing at least a portion of the dry hydrocarbon gas to the jacketed gas thermocompressor as a motive fluid, and flowing at least a portion of the regenerated glycol stream to a jacket of the jacketed gas thermocompressor as a heat exchanging fluid. The method further includes generating a dried off-gas, where the water in the stripped gas is condensed without using an additional cooling system.

In an aspect, combinable with any other aspect, the method further includes exchanging heat between the rich glycol stream and the regenerated glycol stream.

In an aspect, combinable with any other aspect, the method further includes recycling the regenerated glycol stream as at least a portion of the lean glycol for the step of dehydrating the wet hydrocarbon.

In an aspect, combinable with any other aspect, the method further includes, after removing at least the portion of the hydrocarbon impurities, removing at least at portion of solids and hydrocarbons associated in the rich glycol stream using one or more filters.

While this invention has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A method of regenerating glycol from a rich glycol stream, the method comprising:
regenerating glycol by stripping water from the rich glycol stream in a stripper, generating a stripped gas comprising vapor and a liquid comprising lean glycol, the stripped gas having an initial pressure and an initial temperature, a water content of the lean glycol being less than that of the rich glycol stream;
providing the stripped gas to a jacketed gas thermocompressor;
flowing a fuel gas stream into the jacketed gas thermocompressor as a motive fluid for the jacketed gas thermocompressor;
flowing a heat exchanging fluid into a jacket of the jacketed gas thermocompressor; and
discharging a cooled output stream from the jacketed gas thermocompressor, the cooled output stream having an output pressure higher than the initial pressure of the stripped gas and an output temperature lower than the initial temperature of the stripped gas.

2. The method of claim 1, wherein the cooled output stream is a mixture of the stripped gas and the fuel gas stream, and a temperature of the cooled output stream is low enough to allow condensation of the water without an additional cooler system.

3. The method of claim 1, wherein the cooled output stream is a mixture of the stripped gas and the fuel gas stream, the method further comprising recovering the fuel gas stream as an off-gas.

4. The method of claim 3, further comprising combusting the off-gas as a fuel.

5. The method of claim 1, further comprising performing a gas dehydration absorption process of a wet gas using the lean glycol to generate a dry gas and the rich glycol stream comprising the water.

6. The method of claim 5, wherein the wet gas comprises hydrocarbons, the method further comprising, prior to stripping the water from the rich glycol stream in the stripper, removing at least a portion of associated hydrocarbons in the rich glycol stream using a flash drum.

7. The method of claim 5, wherein the wet gas comprises hydrocarbons, the method further comprising using at least a portion of the dry gas as the fuel gas stream flowed into the jacketed gas thermocompressor.

8. The method of claim 1, further comprising using at least a portion of the lean glycol from the stripper as the heat exchanging fluid for the jacketed gas compressor.

8. The method of claim 1, further comprising:
pressurizing at least a portion of the lean glycol from the stripper using a pump, generating a pressurized lean glycol; and
using the pressurized lean glycol as the heat exchanging fluid for the jacketed gas compressor.

9. The method of claim 8, further comprising:
collecting the heat exchanging fluid after the jacketed gas compressor; and
performing a gas dehydration absorption process of a wet gas using the collected heat exchanging fluid to generate a dry gas and the rich glycol stream.

10. The method of claim 1, wherein the initial pressure of the stripped gas from glycol stripper is from 0.1 psig (0.69 kPa) to 8.0 psig (55.2 kPa), and the output pressure is from 20 psig (137.90 kPa) to 50 psig (344.74 kPa).

11. The method of claim 1, wherein the initial temperature is from 180° F. (82.2° C.) to 250° F. (121.1° C.), and the output temperature is from 100° F. (37.8° C.) to 150° F. (65.6° C.).

12. The method of claim 1, wherein the rich glycol comprises hydrocarbons, the method further comprising stripping the hydrocarbons from the rich glycol stream in the stripper while stripping the water.

13. A glycol regeneration system comprising:
a stripper to extract water from rich glycol stream and to generate a stripped gas comprising vapor and a liquid comprising lean glycol, the stripper comprising a reboiler and a stripping column;
a surge tank downstream to the stripper to store the lean glycol; and
a jacketed gas thermocompressor downstream to the stripper to receive, heat, and compress the stripped gas, the jacketed gas thermocompressor comprising a jacket to receive at least a portion of the lean glycol as a heat exchanging fluid,
wherein a water content of the lean glycol is less than that of the rich glycol stream.

14. The glycol regeneration system of claim 13, further comprising a flash drum upstream to the stripper to remove at least a portion of associated hydrocarbons in the rich glycol stream.

15. The glycol regeneration system of claim 13, further comprising a filter upstream to the stripper to remove at least a portion of solids and associated hydrocarbon in the rich glycol stream.

16. The glycol regeneration system of claim 13, further comprising a heat exchanger to exchange heat between the rich glycol stream and the lean glycol.

17. A gas dehydration absorption system comprising the glycol regeneration system of claim 13, wherein the gas dehydration absorption system further comprises a scrubber to treat a wet gas and generate a dry gas and the rich glycol stream.

18. The gas dehydration absorption system of claim 17, further comprising a fluid connection from a gas outlet of the scrubber to a motive fluid inlet of the jacketed gas thermocompressor.

19. The gas dehydration absorption system of claim 17, further comprising a fluid connection from an outlet of the jacket for the heat exchanging fluid to an absorber inlet of the scrubber.

20. A method of dehydrating a wet hydrocarbon gas, the method comprising:
dehydrating the wet hydrocarbon gas in a scrubber using a lean glycol as an absorber, generating a dry hydrocarbon gas and a rich glycol stream comprising water and hydrocarbon impurities;
removing at least a portion of the hydrocarbon impurities from the rich glycol stream in a flash drum;
heating the rich glycol stream in a stripper to vaporize the water and the remaining hydrocarbon impurities as a stripped gas, leaving a regenerated glycol stream as a liquid;
compressing the stripped gas using a jacketed gas thermocompressor by
flowing at least a portion of the dry hydrocarbon gas to the jacketed gas thermocompressor as a motive fluid, and
flowing at least a portion of the regenerated glycol stream to a jacket of the jacketed gas thermocompressor as a heat exchanging fluid; and
generating a dried off-gas, wherein the water in the stripped gas is condensed without using an additional cooling system.

21. The method of claim 20, further comprising exchanging heat between the rich glycol stream and the regenerated glycol stream.

22. The method of claim 20, further comprising recycling the regenerated glycol stream as at least a portion of the lean glycol for the step of dehydrating the wet hydrocarbon.

23. The method of claim 20, further comprising, after removing at least the portion of the hydrocarbon impurities, removing at least at portion of solids and hydrocarbons associated in the rich glycol stream using one or more filters.
